(19) United States
(12) Patent Application Publication
(10) Pub. No.: US 2020/0108965 A1
(43) Pub. Date: Apr. 9, 2020

(54) Machine and Packaging Manufactured Therewith

(71) Applicant: Dienes Werke für Maschinenteile GmbH & Co. KG, Overath (DE)

(72) Inventor: Rudolf Supe-Dienes, Overath (DE)

(21) Appl. No.: 16/592,479

(22) Filed: Oct. 3, 2019

(30) Foreign Application Priority Data
Oct. 5, 2018 (DE) 10 2018 124 586.6

(51) Int. Cl. B65B 61/06; B26D 1/34; B65D 75/12

(52) U.S. Cl. CPC B65B 61/06; B65D 75/12; B26D 1/34

(57) ABSTRACT

A machine for manufacturing packaging with two sealed cross seams and at least one sealed longitudinal seam consisting of at least one heat sealable packing material sheet includes at least one cross seam sealing device; at least one longitudinal seam sealing device; at least one cross cutting device; and at least one longitudinal cutting device.

### CROSS-REFERENCE TO RELATED APPLICATIONS

The present application claims the priority date of Oct. 5, 2018, the filing date of the German patent application DE 10 2018 124 586.6.

### BACKGROUND OF THE INVENTION

The present invention relates to a (pouch) packaging with two sealed cross seams and at least one sealed longitudinal seam consisting of at least one heat sealable packing material sheet and to a (tubular bag) machine for manufacturing such a (pouch) packaging. The machine comprises at least one cross seam sealing device, at least one longitudinal seam sealing device, at least one cross cutting device and at least one longitudinal cutting device.

For example, EP 0 659 645 B1 discloses a tubular bag machine with which zigzag shaped cross edges are fabricated at the edges of the pouch packages allocated to the cross seams. These zigzag shaped cross edges make it easier to open the packaging.

Also known from EP 0 797 526 B1 is a machine, in which the cutting device can be used to detach the unsealed region of the packing material strip protruding over the longitudinal seam to produce a straight longitudinal edge. The packaging fabricated in this way can be easily opened proceeding only from the cross edge having a zigzag shape. But in order to open the packaging from the longitudinal edge, it is also known to introduce additional perforations into the packaging. To this end, however, an additional step is required to generate these straight perforations that in particular run transverse to the longitudinal seam.

CH 651 795 A5 discloses a machine, in which cutting edges to produce such cuts (perforation) extending obliquely to a straight longitudinal edge of the packing are incorporated into the longitudinal seam sealing device.

EP 1 593 603 A1, JP 2013-103766 A, and US 2004/0124115 A1 each disclose machines, in which packing material sheets having undulating edges are provided to the longitudinal seam sealing device, wherein a packaging with only one longitudinal seam is formed.

### SUMMARY OF THE INVENTION

Therefore, the object of the present invention is to eliminate the disadvantages described relative to prior art, and in particular to indicate a packaging as well as a machine suitable for its production, which make it easier to open the packaging.

The object is achieved in particular by a (tubular bag) machine with the features mentioned at the outset, wherein the at least one longitudinal cutting device has a blade with an undulating cutting edge, thereby making it possible to generate at least one longitudinally running edge of the packaging allocated to the sealed longitudinal seam that is undulating in design.

Accordingly, the invention also proposes a packaging in which at least one longitudinally running longitudinal edge allocated to the sealed longitudinal seam has an undulating shape.

An “undulating cutting edge” means that the cutting edge of the blade is designed in a meandering, wavelike or zigzag manner transverse to the primary plane of the blade, for example.

The basic idea underlying the invention, therefore, is that not just the cross edges allocated to the cross seams have an undulating, in particular zigzag or wavelike shape, but that also the at least one edge allocated to the at least one sealed longitudinal seam has a correspondingly undulating (e.g., wavelike or zigzag) shape over its entire length. This makes it possible to easily open the packaging not just proceeding from the cross edges, but also proceeding from the longitudinal edge at any point.

The (pouch) packaging is designed as a 4-edged (pouch) packaging, which has two sealed longitudinal seams and two sealed cross seams, wherein the two longitudinal edges, which are each allocated to a sealed longitudinal seam, have an undulating shape over their entire length. In this connection, it is preferred that the machine comprises at least two longitudinal seam sealing devices and/or at least two longitudinal cutting devices with a respective blade having an undulating cutting edge. If several longitudinal sealing devices (e.g., two, three or more) are provided, each longitudinal seam sealing device can have allocated to it (in particular, behind the respective longitudinal sealing device in the running direction of the packing material sheet) a respective longitudinal cutting device, wherein the longitudinal cutting devices are preferably aligned parallel to each other.

In particular, the packaging can be made out of exactly one heat-sealable packing material sheet. Exactly one longitudinal sealing device can be used to fabricate a tubular bag out of the exactly one packing material sheet, wherein the exactly one longitudinal sealing device has allocated to it (in particular, behind it) exactly one longitudinal cutting device.

However, in order to manufacture several packaging strips running parallel to each other, it can also be provided that several longitudinal seam sealing devices, in particular aligned parallel to each other, are provided, which each produce at least one sealed longitudinal seam and generate the parallel strips of packaging (in the feed direction of the tubular bag) in the tube.

But it can also be provided that the packaging is manufactured out of two heat-sealable packing material sheets, wherein the packing material sheets initially run parallel to each other and are connected with each other by the sealing devices. In order to manufacture only a single packaging strip out of two heat-sealable packing material sheets, at least two (longitudinal) sealing devices must be provided, wherein preferably each longitudinal seam sealing device has allocated to it (behind it) a longitudinal cutting device. Several longitudinal seam sealing devices and longitudinal seam cutting devices must be correspondingly provided for several parallel running pouch package strips.

In particular, a longitudinal cutting device and/or its blade can be set up and/or operated in such a way that, in order to manufacture several parallel running pouch packaging strips, only one weakened area having an undulating shape, such as a perforated cutting line, is introduced between two packaging strips, along which the packaging strips are later separated from each other, if necessary manually, so that the separation results in the longitudinal edge. In order to generate the perforated line, the undulating cutting edge in particular has recesses or projections, which extend transverse to the undulation in about the main plane of the blade. The projections generate successively arranged slots in the packing material sheet, so that adjacent packaging strips remain easily detachably connected via the material situated between the slits.

The blades of the at least one, in particular of all longitudinal cutting device(s), is a circular blade, the cutting edge of which has an undulating design.

If several longitudinal cutting devices are provided, the circular blades can all be mounted on a common shaft, in particular for driving the circular blades.

Alternatively, it can be provided that each longitudinal cutting device comprises a blade holder, to which a respective (circular) blade is attached, wherein the blade holders can each be secured to a traverse. In a detached position of a securing device of the blade holder, the blade holders are each arranged so as to be displaceable along the traverse. As a result, the machine can be easily adjusted for packagings of different width.

In particular for finely adjusting the blades, it can be provided that the blade holder comprises a preferably manually operable control element designed as a dial, for example, which can be used to adjust the blade held by the secured blade holder parallel to the traverse.

The longitudinal cutting devices can each comprise at least one electromechanical, pneumatic or hydraulic actuator, with which the respective blade can be positioned to the packing material sheet already having the sealed longitudinal seam(s) produced by the respective longitudinal seam sealing device.

The circular blade of the respective longitudinal cutting device can be actively driven into a rotational movement by the respective longitudinal cutting device. Alternatively, it also can be provided that the circular blade is pressed onto a packing material sheet (in particular, already having the sealed longitudinal seam(s) produced by the respective longitudinal seam sealing device) by means of an actuator of the longitudinal cutting machine, and then driven into rotation by the (linearly) moving packing material strip.

### BRIEF DESCRIPTION OF THE DRAWINGS

The invention along with the technical environment will be explained below based upon the figures. In the figures:

FIG. 1 shows a first embodiment of longitudinal cutting devices of a (tubular bag) machine;

FIG. 2 shows a second embodiment of longitudinal cutting devices of a (tubular bag) machine;

FIG. 3 shows a side view of the longitudinal cutting device according to FIG. 2; and

FIG. 4 shows a zigzag section with perforation.

### DETAILED DESCRIPTION OF THE EXAMPLE EMBODIMENTS

Tubular bag machines as such are known from prior art, so that only the longitudinal cutting devices will be discussed below.

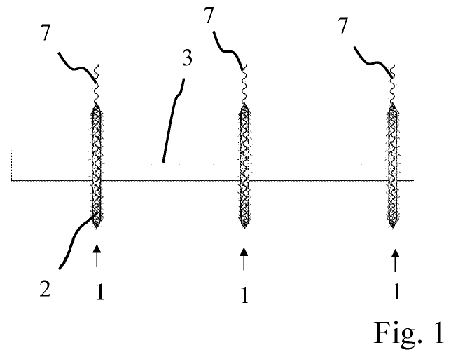

FIG. 1 shows a shaft 3, upon which are mounted several blades 1 designed as circular blades, wherein the blades 1 have a wavelike cutting edge 2. The shaft 3 can either be actively driven, so that the blades 1 are driven into a rotation. Alternatively, however, it could also be provided that the blades 1 are pressed onto a packing material sheet (already having the sealed longitudinal seam(s) produced by the respective longitudinal seam sealing device) with the shaft 3, and that the shaft 3 be driven into rotation by the linearly moving packing material strip.

Each blade 1 generates a wavelike cut 7 to produce a wavelike longitudinal edge of a packaging.

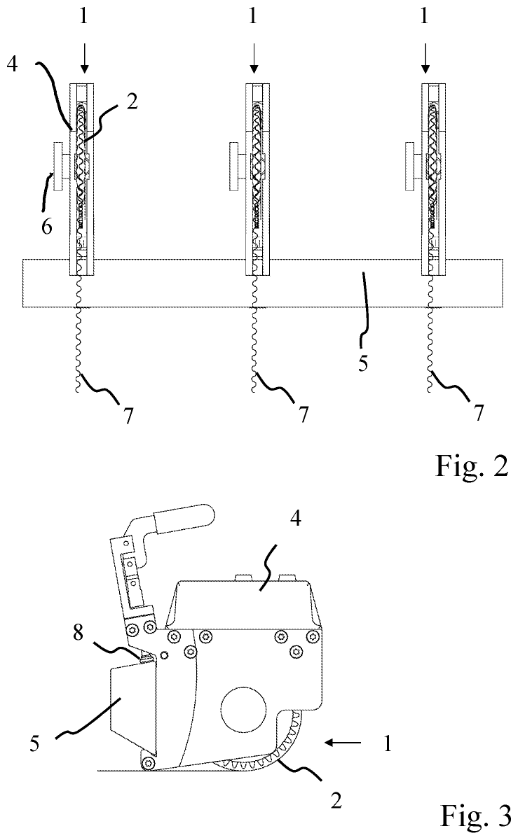

According to the embodiment on FIGS. 2 and 3, each longitudinal cutting device has a blade holder 4, which carries a respective blade 1, likewise designed as a circular blade and having a wavelike cutting edge 2, so that each blade 1 generates a wavelike cut 7 to produce a wavelike longitudinal edge of a packaging. Each blade holder 4 has a dial 6, which can be used to adjust the respective blade 1 parallel to a traverse 5. In the detached state of a fastening device 8, the blade holders 4 can also be moved along the traverse 5, so that the distance between the blades 1 can be easily changed even by a large distance. In particular, the blade holders 4 have an actuator, with which the respective blade 1 can be delivered to the packing material sheet.

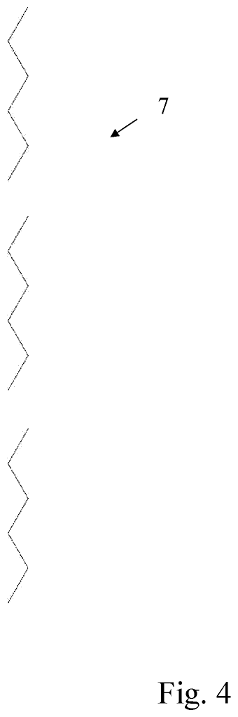

FIG. 4 shows a zigzag cut 7, which is also perforated. To this end, the cutting edge 2 of the blade 1 can be zigzagged in design transverse to the circumferential direction, while the cutting edge 2 has recesses in the radial direction of the blade, based on which the perforation is generated. In this way, parallel packaging strips can be produced, which can be separated along the perforated cut, so that the manually separated pouch packaging also has a zigzag longitudinal edge.

The specification incorporates by reference the disclosure of DE 10 2018 124 586.6, filed Oct. 5, 2018.

The present invention is, of course, in no way restricted to the specific disclosure of the specification and drawings, but also encompasses any modifications within the scope of the appended claims.

1. A machine for manufacturing packaging with two sealed cross seams and at least one sealed longitudinal seam consisting of at least one heat sealable packing material sheet, comprising:
at least one cross seam sealing device,
at least one longitudinal seam sealing device;
at least one cross cutting device; and
at least one longitudinal cutting device,
wherein one of the at least one longitudinal cutting device is allocated to each of the at least one longitudinal seam sealing device, and wherein the at least one longitudinal cutting device has a circular blade (1) with an undulating cutting edge (2) to generate at least one longitudinally running edge of the packaging allocated to the at least one sealed longitudinal seam that is undulating in design over its entire length.

2. The machine according to claim 1, wherein the circular blades of several longitudinal cutting devices are mounted on one common shaft (3).

3. The machine according to claim 1, wherein the circular blades of all of the longitudinal cutting devices are mounted on one common shaft (3).

4. The machine according to claim 1, wherein each longitudinal cutting device comprises a blade holder (4), wherein the blade holder (4) is securable to a respective traverse (5).

5. The machine according to claim 4, wherein each blade holder (4) is displaceable along the traverse (5).

6. The machine according to claim 4, wherein the blade (1) held by the secured blade holder is adjustable parallel to the traverse (5).

7. The machine according to claim 1, wherein the blade (1) is configured to form a perforated cut.

8. A packaging, comprising:
two sealed cross seams and two sealed longitudinal seams consisting of at least one heat sealable packing material sheet, wherein the two cross edges have an undulating shape, and wherein two longitudinally running longitudinal edges allocated to the two sealed longitudinal seams have an undulating shape.

9. Use of a blade in a machine, wherein the blade is a circular blade and has an undulating cutting edge (2) and is used to manufacture a longitudinal edge of a packaging that is allocated to a sealed longitudinal seam of the packaging.
